(19) United States
(12) Patent Application Publication
(10) Pub. No.: US 2017/0337780 A1
(43) Pub. Date: Nov. 23, 2017

(54) GAME OF CHANCE, THINKING AND STRATEGY

(71) Applicants: Michael Brockman, Calabasas, CA (US); Robert Noah, Beverly Hills, CA (US)

(72) Inventors: Michael Brockman, Calabasas, CA (US); Robert Noah, Beverly Hills, CA (US)

(21) Appl. No.: 15/583,675

(22) Filed: May 1, 2017

Related U.S. Application Data
(60) Provisional application No. 62/329,490, filed on Apr. 29, 2016.

(51) Int. Cl. G07F 17/32; A63F 13/80; A63F 1/00

(52) U.S. Cl. CPC G07F 17/3293; A63F 13/80; A63F 2300/407; A63F 1/00

(57) ABSTRACT

Games requiring thinking and strategy are provided with concealable cards or game pieces, physical or virtual, which can be played on a game board which may be a square or rectangular grid or other shape. Together the cards or game pieces are a collection of sets and there may be more spaces on the game board than there are cards or game pieces in the collection. The cards may be a subset of a regular deck of cards, such as five sets of four cards of the same value, each of different suits, wherein these 20 cards are to be played on a 5×5 game board so that there are 5 extra spaces that will be empty after all cards are played. Cards may be played one at a time or grouped and some may be concealed before being played, with the order of concealed and revealed varying. A player aims to place the cards or game pieces to form combinations such as four of a kind in value in either rows or columns to score points. Other combinations may be played for such as three of a kind, flushes, full houses etc. and these may be obtained in different directions on the board. Points are tallied at the end when all cards or game pieces have been played, and prizes may be awarded for points scored after one or more games. Games may be played by one or more players, and the rules may incentivize two or more players to collaborate or compete. Wild card and jokers may be included at various stage of play.

### CROSS-REFERENCE TO RELATED APPLICATIONS

This non-provisional patent application claims priority under 35 U.S.C. §119(e) to U.S. Provisional Patent application, Ser. No. 62/329,490, filed 29 Apr. 2016, the disclosure of which is incorporated herein by reference.

### FIELD OF THE INVENTION

This invention relates to games.

### BACKGROUND

The entertainment industry is always looking for new, innovative, challenging, and fun games. Most games generally test a player's knowledge. Some games are based on timing, luck, or skill. Very few games actually deal with strategizing and thinking, or combine strategizing and thinking with timing, luck, or specific skill. For the foregoing reasons, there is a need for more games that not only test and reward a player's luck but also their ability with thinking and strategizing.

There are many games that one player may play by themselves. Card games, for example, are very popular. One example of a card game is solitaire. A version of this game is poker solitaire, wherein points are scored for achieving poker type combinations of cards. As it is typically played, an entire 52-card deck is used to play only a portion of the cards. While some strategy and skill is helpful, much of the outcome of the game is due to luck. There is a need in the art for more games that players can play themselves, with physical game pieces such as cards, on electronic devices, and in casinos, that entice the player to use and receive benefit from applying more strategy and thinking.

Game shows, which have historically been shown on television, include a variety of different games that one or more contestants may play. Games must engage an audience as well as contestants, and the games preferably involve competitive aspects that the audience can participate in, rather than merely luck. Games for such shows have an ideal probability that a contestant will win that keeps an audience engaged and offers prizes that are for enough but not too much value, based on how much advertising revenue the show brings in. There is a need in the art for games that can be played by one or more player, are easily modifiable in how hard or easy they are to win, and that actively engage an audience.

### SUMMARY

The present invention is directed to methods for playing games and to games having more spaces on a game board than game pieces with the objective to place groups of the game pieces in areas on the game board, optionally for points and prizes. Some game pieces are dealt and played concealed and some revealed. The games may be played alone, as in solitaire, or with more than one person. People can play together or compete, such as playing electronically and getting the same cards dealt in the same order and competing for higher scores each using their own strategy. The percentage of extra spaces or locations impacts the likelihood of scoring, as does the percentage or game pieces concealed.

### BRIEF DESCRIPTION OF THE DRAWINGS

FIG. 1 shows an illustration of an example of a game board of this invention.

FIG. 2 shows an illustration of an example of an outcome of a game of this invention.

FIG. 3 shows an illustration of an example of the beginning of a game of this invention.

FIG. 4 shows an illustration of an example of an outcome of a game of this invention with some groups designated.

FIG. 5 shows two illustrated examples of game pieces of this invention, FIGS. 5A-5B.

FIG. 6 shows an illustration of an example of the beginning of a game of this invention.

### DETAILED DESCRIPTION OF THE INVENTION

The detailed description set forth below in connection with the appended drawings is intended as a description of embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of this invention.

The present invention is for a new game involving knowledge, quick thinking, and strategy as well as some chance and luck.

In embodiments, prizes for selected score levels are in the form of cash prizes, gift certificates, vacations, consumer goods, access to additional games and game stages, and the like.

A player may physically place a card or game piece, or may have an opportunity to submit their choice of where to place that card or item by activating an actuator. An actuator may be a button, a lever, a touchscreen, and the like. In some embodiments, each contestant may be presented with multiple actuators, with each actuator associated with each one of the available choices. Therefore, activation of a specific actuator determines the player's selection of his or her play. In embodiments using touch screens, the number of actuators is in reference to the number of areas on the screen, actuation of which submits the answer selected. In some embodiments, multiple touch screens can be dedicated for each choice, for each player.

In a game of this invention, a player is presented with a game board having a plurality of spaces and a real or virtual collection of a group of concealable sets of game pieces, such as a deck of cards or a subset of a standard deck of cards. The set can also be made up of sets of game pieces that function like cards (are concealable and revealable) but are not cards. These game pieces can be electronic, such as on computerized equipment. The game pieces may be tiles, pieces or any other game piece that can be used to play the game, or a computer representation of any such game pieces. The game pieces are designed on a scale that will provide for proper operation of the game, being large enough for a player to handle conveniently and to see easily the markings on the game piece, and small enough to fit onto a game board of a convenient size.

In an embodiment, the number of spaces on the game board compares to the size of the collection by a space:collection ratio. In an embodiment the space:collection ratio is selected from between 2:1 and 2:3, between 3:2 and 3:4, between 8:5 and 5:6, more than 1:1, between 4:3 and 25:24, between 16:11 and 18:17, between 9:7 and 10:9, between about 5:4 and 7:6, between about 5:4 and about 6:5. In an embodiment, the space:collection ratio is about 5:4. In an embodiment, the number of spaces exceeds the size of the collection.

In an embodiment, there are 30 spaces and the collection has 24 cards or game pieces. In an embodiment, there are 25 spaces and the collection has 20 cards or game pieces. In an embodiment, there are 18 spaces and the collection has 15 cards or game pieces. In an embodiment there are 36 spaces and the collection has 30 cards or game pieces. In an embodiment there are 16 spaces and the collection has 12 cards or game pieces. In an embodiment, there are 20 spaces and the collection has 16 cards or game pieces. In an embodiment, there are 10-12 spaces and the collection has 9 cards or game pieces. In an embodiment, there are 5-6 spaces and the collection has 4 cards or game pieces.

In an embodiment, the sizes of the sets of cards or game pieces in the collection are the same as or smaller in size than the number of spaces in one row or column or equivalent shape of spaces on the board that is used for scoring a game of this invention.

In an embodiment, a collection of 20 cards includes 5 sets of 4 cards or game pieces each. And example are the 4 tens, 4 jacks, 4 queens, 4 kings and 4 aces in a deck of cards with the standard 4 suits. In various embodiments, a collection of 15 cards or game pieces includes 5 sets of 3 cards each, a collection of 24 cards has 6 sets of 4 cards each, a collection of 30 cards has 6 sets with 5 cards each or 5 sets with 6 cards each, and a collection of 12 cards has 4 sets with 3 cards each or 3 sets with 4 cards each.

Differently sized sets can be in a collection as well. For example, there can be 4 twos, 4 threes, 4 fours and 2 fives, 2 sixes, 2 sevens, and 2 eights.

In an embodiment, a game board of this invention is square, such as 6×6, 5×5, 4×4 or 3×3. In an embodiment, a game board of this invention is a rectangle, with one side being only one space shorter than the other, such as 6×5, 5×4, 4×3, etc. In an embodiment, the game board is rectangular, where one side of the game board is shorter. When the board is rectangular, the sets in the collection, for example, may be the same size as the shorter side of the board, e.g., in a 6×5 board, there are sets of 5 cards or game pieces, and likely there are 5 of these sets for 25 cards.

In another embodiment, a game board is rectangular with 6 rows of 4 spaces each. Likely there are 5 sets of 4 cards each for 20 cards. Game boards may be shapes other than squares or rectangles. A board could be configured, for example, as a cross or a square or perhaps any shape in which the stretches of cards or game pieces that are counted and scored together are somehow designated.

In an embodiment, when game boards are square or rectangular, it is first determined if the cards or game pieces are to be scored in only one direction or in more then one direction. If only one direction in a square board is scored, typically the rows or columns are selected for scoring. In a rectangular board, while it can be either rows or columns, it typically is the rows or columns in which all the sets in the collection can fit. Such as, if the sets are four cards in a 5×4 spaced board, they can get scored in the direction that has 4 spaces or 5 spaces, whether the horizontal rows or the vertical columns, relative to the ground or the player. In an embodiment, the method for scoring is determined before the player plays, and in another embodiment, the method is determined after play, based on whichever approach yields the highest score. In an embodiment, there is one extra row or column beyond how the cards fit if they are all placed in the scored sections of the board, so that there is one fewer set than the longer of the rows or columns.

The sets can be selected so they are not all of equal size and the game board shape is selected to relatively align, in some way, with the sizes of the sets.

The player's aim, what is scored, may simply be getting all the cards of one set in one row or column (or equivalent in an unusually shaped board). Optionally a range of points is awarded for having portions of a set in one row or column, typically increasing as the entire set is approached, or only for having the entire set in a row or column. In an embodiment, more points are awarded or points are only awarded when the cards in one set are all adjacent to one another with no other cards in between. When playing this way, there are more strategies available for getting an entire set of cards adjacent in a row or column or other section that is longer or larger than the set.

In an embodiment, points may be scored both for rows and columns. In an embodiment, different aspects of the cards may be scored. If only one aspect is scored, it may simply be how many of that set are in that row or column. If playing with twos, threes, fours, fives and sixes from a standard 52-card deck, it maybe getting all four of the twos in one row or column, all the threes in own row or column, etc. Alternatively, points may be given for getting three of one of these sets in a row or column, and optionally for two as well. Alternatively, the sets may be determined by suit, and points are given for getting all and/or a portion of, all of the hearts, spades, etc. in a row or column.

Both aspects may also be scored, as typically is in poker solitaire, whereas in one of the rows or columns, the player is generally aiming for sets of value of the card (e.g., all the twos in a row or all queens) and they spontaneously choose while playing to aim for getting all of one suit in the other (e.g., all of each suit in the columns). What can be scored in which row or column can be predetermined and exact, and/or it can be guided within constraints, such as only values in rows and suits in columns or vice versa. Which value or suit is aimed for and can be scored in each row or column can be predetermined too, or this may be left up to the player. Typically having some freedom for the player is more engaging.

Another aspect that can be scored is the number of cards of all one suit, whereas longer stretches are likely to be more valuable than shorter stretches. Also, the order of the values of the cards may matter, such that having straights in a row or column (or equivalent place) may also be worth points. Since the sets described so far are contiguous values (twos, threes, fours, fives, etc.) all sets of all of one suit are going to also be straights (a straight flush). This is much less likely in the game poker solitaire where there are 5 spaces in each row and column and thirteen cards in a suit. To utilize this scoring possibility, the cards chosen can be, for example: twos, threes, fours, fives and sevens, and more points may be awarded for having the straight-forming cards adjacent, physically next to each other, even optionally in the exact order. Having all the cards of one suit together in this example would be a flush, but not a full straight.

It can also be determined before starting if more combinations of the cards can be scored, such as are in poker solitaire. Examples include a full house (in a row of 5, a pair and a triple, even though both are of different values on the cards and different suits. Many options are possible.

An example of poker solitaire scoring is as follows: each column and each row are scored according to the following chart. No points are awarded for diagonals.
Royal flush, 50
Straight flush, 30
Four of a kind, 16
Straight, 12
Full house, 10
Three of a kind, 6
Flush, 5
Two pairs, 3
One pair, 1

Fewer card combination options are possible in the games of this invention because there are often fewer cards or game pieces than spaces, and also the collection of cards is likely preselected to have relatively large sets, not randomly selected cards from a large deck.

The combinations that can be scored will impact the strategy used for placing the cards or game pieces in the collection. In a 5×5 board with 5 sets of 4 cards, only playing to get the same values in the same row, the player will choose which rows are for building which values, and this may change depending on other game rules (such as described below, as this may lead to a change in strategy mid-game). The player puts each card in the row it likely or best belongs with each turn. This leads to an obvious win unless new features of the game are added.

In an embodiment, the cards or game pieces are put in to play in an order, with some revealed before they are placed on the board by the player, and sometimes they are kept concealed from the player until after they are placed (or even not revealed until later or at the end of the game). Just as there is a space:collection ratio or percentage, there also is a concealed:revealed ratio or percentage and also an order of when they are revealed: some before placing and some which are concealed until after being placed.

In an embodiment, all the cards or game pieces in the collection are revealed before being placed on the board for a 0:1 ratio. In other embodiments, the concealed:revealed ratio is between 1:0 and 1:0, 1:24 and 12:1, between 1:17 and 6:1, between about 1:9 and 2:1, between about 1:8 and 1:1, between about 1:7 and 1:2, between about 1:6 and about 1.3, or between about 1:5 and about 1:4.

In an embodiment, a game board is 5×5 spaces and a collection of 20 cards having 5 sets of 4 is played in the sequence: 1 concealed (and revealed right after placement on the board), 2-4 revealed (in sequence, played one at a time), 5 concealed (again revealed after placement), 6-8 revealed, 9 concealed, 10-12 revealed, 13 concealed, 14-16 revealed, 17 concealed, 18-20 revealed. In another embodiment, card 19 is also concealed.

This impacts game strategy as the player may change what they are aiming to build in each of the rows depending on where concealed cards land and what value they are. The more cards that are concealed, the more that is left to chance. There are good concealed:revealed ratios that maximize the amount of strategy needed given the amount of random chance and luck in the mix. If more combinations can be scored and columns count as well as rows, even more strategy and complexity and change can happen.

In another embodiment, cards or game pieces that function as wild cards or jokers are added to the deck at some point in play. For example, in an embodiment, before cards 19 and 20 are played, while they are still concealed, either a joker that is essentially a dead card counting for nothing, or a wild card (which can be whatever the player wants it to be) are added. The cards are shuffled so that the player does not know which cards are which. There is a statistical chance which cards the player will draw. If one or more jokers or wild cards are drawn, likely the remaining cards will be played concealed for more drama.

In an embodiment, the order and number of cards placed at one time can be changed, which is impactful if two or more concealed cards are played simultaneously. An example is if both cards 5 and 6 in the example above are concealed and played at the same time before revealing them.

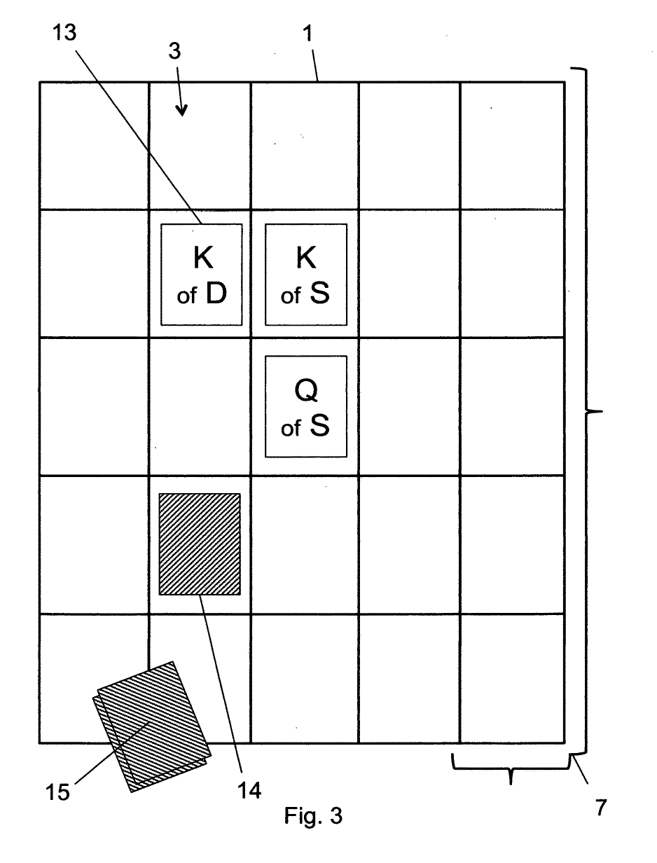

FIG. 3 is an illustration of an example of a game of this invention. The game board 1 has 25 locations 3 arranged in a 5×5 rectangle which is also a square (in terms of the number of locations). Four cards have been played, the 4^{th} card played concealed 14. Three revealed cards are shown, and one revealed card 13 is labeled. An example of an area 7 that is a column is currently empty. The not yet played cards of the randomly shuffled set of game pieces 15 is a subset of a standard deck of cards.

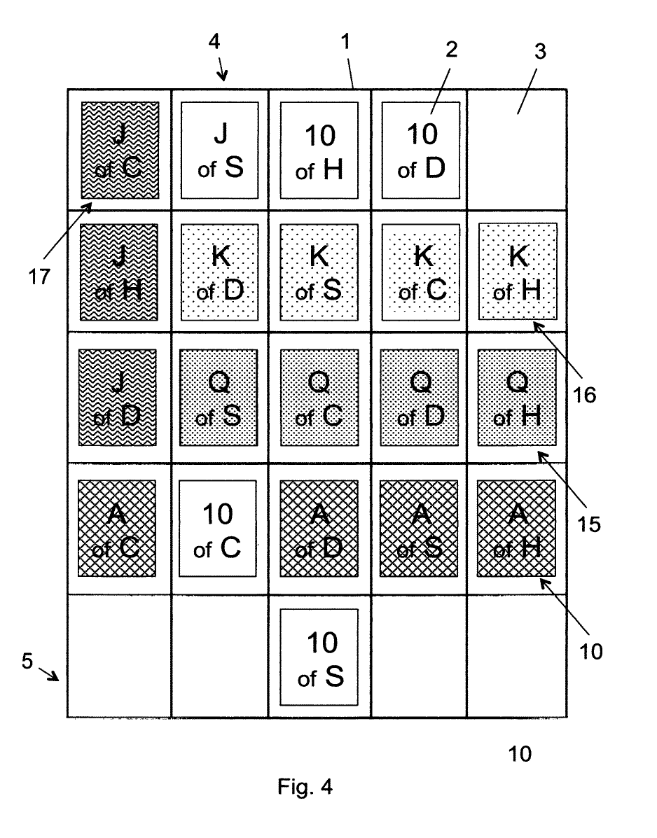

FIG. 4 is an illustration of an example of an outcome of a game of this invention. The game board 1 has 5 more locations 3 than the set of playing pieces. There is not more than one playing piece 2 in a location 3. All these playing pieces 2 are revealed. Some locations 3 are empty after the set of playing pieces is all played. There is not wild card or joker in this example. A row 5 and a column 4, two different areas on this game board 1 are marked. Some groups and subsets of some groups are marked. Group 15 of Queens, shown with dense dots, would be scored because all members of that group are together in one row and adjacent one another—in this game, it is clear that at least row areas are being scored. Group 16 of Kings, shown with diffuse dots, would be scored because all members of that group are together in one row and adjacent to one another. Group 10 of Aces, shown with diagonal cross hatches, may or may not be scored depending on what scoring instructions are being used since they are all in one row but not all adjacent. Some of the members of group 17 of Jacks are marked with zigzag lines, and they could possibly be scored depending on what scoring instructions are being used because 1) they are a column, not a row, and they only would get scored if columns are being scored in this game, plus 2) not all members of that group are in one area (one column), but 3) they are at least adjacent. It is possible they will earn the player some score.

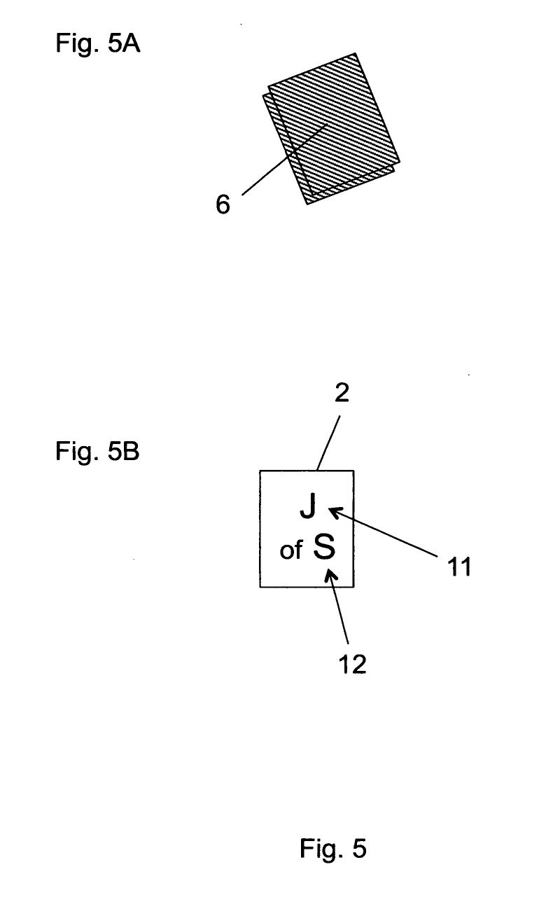

FIG. 5A shows an example of a set 6 of concealed game pieces (more are under the ones that are visible) of this invention. FIG. 5B shows an example of a game piece 2 of this invention with an example of a first means 11 and a second means 12 visible. The first means 11 shows that the card is a Jack and the second means 12 shows the card is a Spade suit.

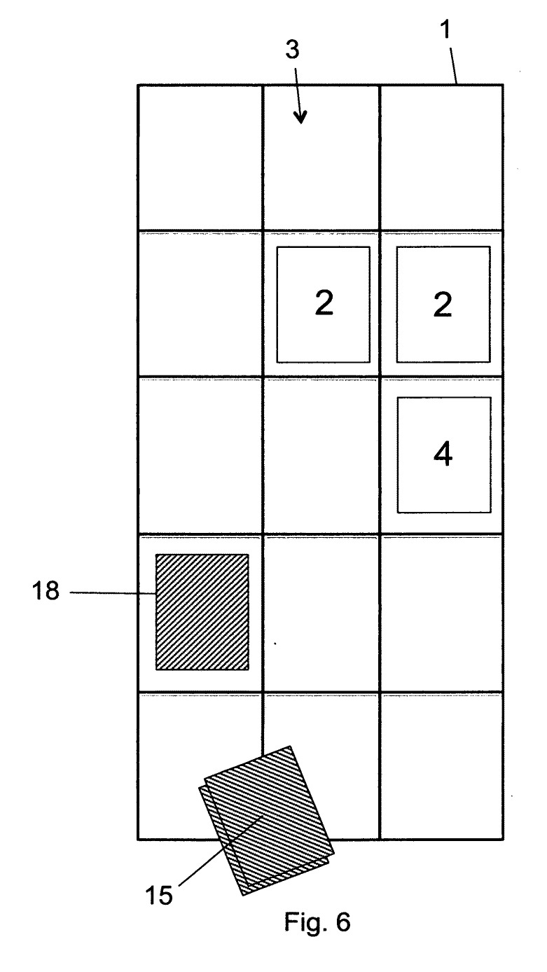

FIG. 6 shows an example of a game board 1 of this invention with 15 locations in a 3×5 rectangle pattern, one empty location 3 marked. Some cards have been played. The fourth card that was just played is concealed 18 and is about to be revealed. More game pieces from the set 15 remain to be played. There are a total of 12 game pieces in this set. Cards are being played in a one at a time rhythm. There is a 12/15 ratio of game pieces to spaces or 80%. There is 25% more space than game pieces. So far, 25% of the cards are being played concealed. There is only a first means for grouping the cards, and the areas are the 5 rows.

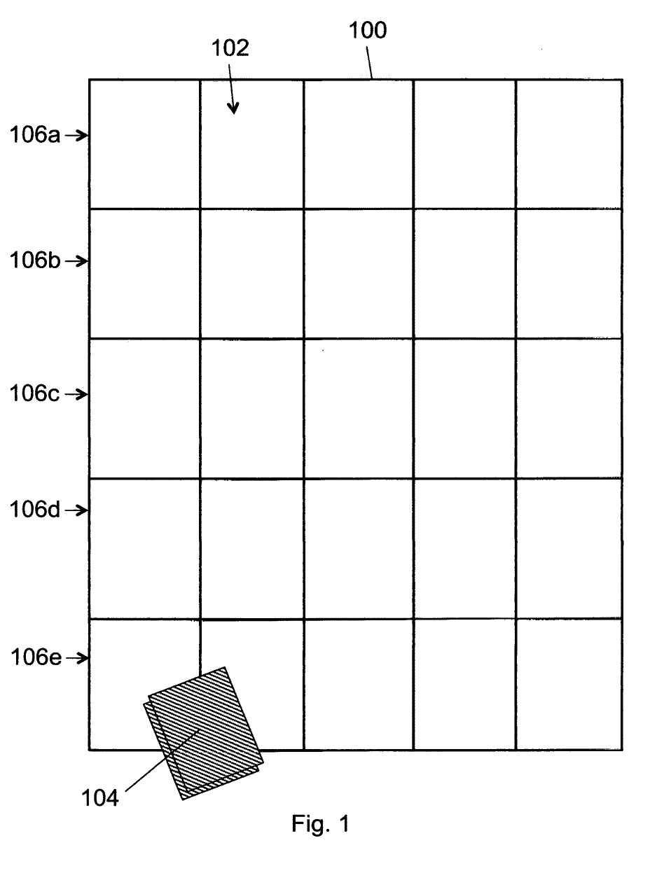

FIG. 1 shows an example of a game of this invention. A player is presented with a game board 100 having a plurality of spaces 102, and real or virtual a deck of cards 104 or group of game pieces. The number of cards may not necessarily equal a regular full deck of 52 cards; however, the number of spaces preferably exceeds the number of cards.

For example, as shown in FIG. 1, the game board is a five (5) by five (5) grid. Therefore, the game board has 25 spaces. In this example, the game can be played with 20 cards from a standard deck of cards, such as, the three face cards, the aces, and the ten cards. To commence this second stage of the game, this deck of cards is shuffled and presented with the cards face down to the player of the first stage so that the player cannot see the value of the cards. The object of the bonus round is for the player to place the cards on the game board so that matching cards are placed near each other, for example, in a horizontal row 106a, 106b, 106c, 106d, 106e. In other words, the ultimate goal of the player is to place all the Aces in one row, all the Kings in a second row, all the Queens in a third row, all the Jacks in a fourth row, and all the tens in a fifth row. Achieving this goal results in the maximum amount of prizes for the player.

The games of this invention may also be played with more then one player at a time. In an embodiment, players take turns placing the cards or game pieces. In an embodiment, one player is scoring rows and the other is scoring columns. Depending on which combinations they are building (e.g., values or suits) they may collaborate or compete.

As described in this embodiment, the manner in which the player places the cards onto the game board grid is based on the following rules. First, a money card is introduced and revealed. The money card can be any card that is not one of the cards that have been given to the player. In this example, the money card cannot be an Ace, King, Queen, Jack, or ten. In this example, the money card is the Joker. The money card is set aside temporarily.

Next, the player is instructed to begin placing the cards 104 that he has received onto the grid or game board according to the following rules.

The player is to take the first card, face down, and place it on any available space on the grid without knowing the value of the first card. Once the first card is placed on one of the spaces on the grid, the first card can be revealed.

Next, the player takes and reveals the second card. Knowing what the second card is, and knowing what the first card is and where it has been placed, the player strategically places the second card on one of the available spaces on the grid face up, keeping in mind that the objective is to place all matching cards within the same row. By way of example only, if the first card was an Ace and the second card is an Ace, then the player would want to put the second card in the same row as the first card. If the second card was not an Ace, then the player would want to put the second card in a different row.

Once the second card has been placed, the third card is taken, revealed, and strategically placed on one of the available spaces on the grid face up, keeping in mind the objective of the game. Once the third card has been placed on the grid, the fourth card is taken, revealed, and placed face up on an available space on the grid, keeping in mind the objective of the game. Next, the player takes the fifth card, face down and places it on one of the available spaces on the grid, not knowing what this fifth card is. The player must consider whether this fifth card matches any of the previously placed cards that are now face up. If the player thinks the fifth card matches any of the cards facing up, then he would want to put the fifth card in the same row as the presumed matching card. If the player thinks the fifth card has a value that has not been seen yet, then he would want to put the fifth card in a new row with no cards. After the fifth card is placed on the grid, the fifth card is revealed (turned face up) and the player realizes whether he placed the fifth card appropriately or not.

The player then takes the sixth card, reveals it, and strategically places the sixth card face up on one of the available spaces on the grid, keeping in mind the objective of the game. This continues for the seventh and eighth cards, in series, one at a time.

The player continues this process of placing one card face down on an available space on the grid, revealing it (by turning it face up) after its position on the grid has been established, and placing the next three cards face up on available spaces on the grid, in series, one at a time, until he reaches the 18th card. Therefore, in this example, the ninth card is placed face down on one of the available spaces on the grid, then turned face up. The 10th card is revealed and placed face up on the grid, after which the 11th card is revealed and placed face up on the grid, then the 12th card is revealed and placed face up on the grid. The 13th card is then placed face down on an available space on the grid, then turned face up. The 14th card is revealed and placed face up on the grid, followed by the 15th card, which is revealed and placed face up on the grid, followed by the 16th card, which is revealed and placed face up on the grid. The 17th card is then placed face down on the grid, then revealed by being turned face up.

When the player reaches the 18th card, he reveals the 18th card and places it face up on an open space on the grid.

The remaining two cards are kept face down and the money card 114 is added face down to the remaining two cards. The three cards are shuffled, and the player places two cards face down on available spaces, and places the last card outside of the grid. The two cards placed on the grid are revealed, as well as the card placed off the grid, to see how successful the player was in achieving the objective and keeping the money card off the grid.

Based on the teachings above numerous variations and modifications exist that are within the spirit and scope of the present invention. For example, in some embodiments, the money card may be omitted so that at the end of the game, the remaining two cards are placed on the grid, then revealed. The timing of revealing the cards that were placed on the board can be modified to be revealed at the end of the game after all the cards are placed on the grid. The sequence of placing cards face down versus face up can be varied. For example, three cards can be placed up first, then a card face down, or the cards being placed face up and face down can alternate with every card. The number of cards being placed face up or face down can be varied. These and numerous other variations may be implemented.

Ultimately, the ability to place cards of the same value in the same row by placing some cards face down, and some cards face up. (and eventually revealing all the cards) determines how the player is rewarded.

In this example, the player is rewarded as follows. If the player is able to get three cards of the same value next to each other in the same row, the player is awarded a prize. In this example, the prize may be $5000. Therefore, the final contestant is awarded $5000 for each instance in which the he was able to get three cards of the same value next to each other in the same row.

For each instance the player is able to get four cards of the same value next to each other in the same row (with no other cards between), the player is awarded a greater prize. In this example, the greater prize may be $10,000 for each instance the player is able to get four cards of the same value next to each other in the same row.

Bonus prizes may be awarded for achieving an outcome with a very low probability. For example, a bonus prize may be awarded if the player is able to get all of the cards having the same value next to each other in their respective rows. Therefore, in addition to the greater prize awarded for each set of four cards of the same value in their respective rows, the player receives a bonus prize of, for example, $100,000.

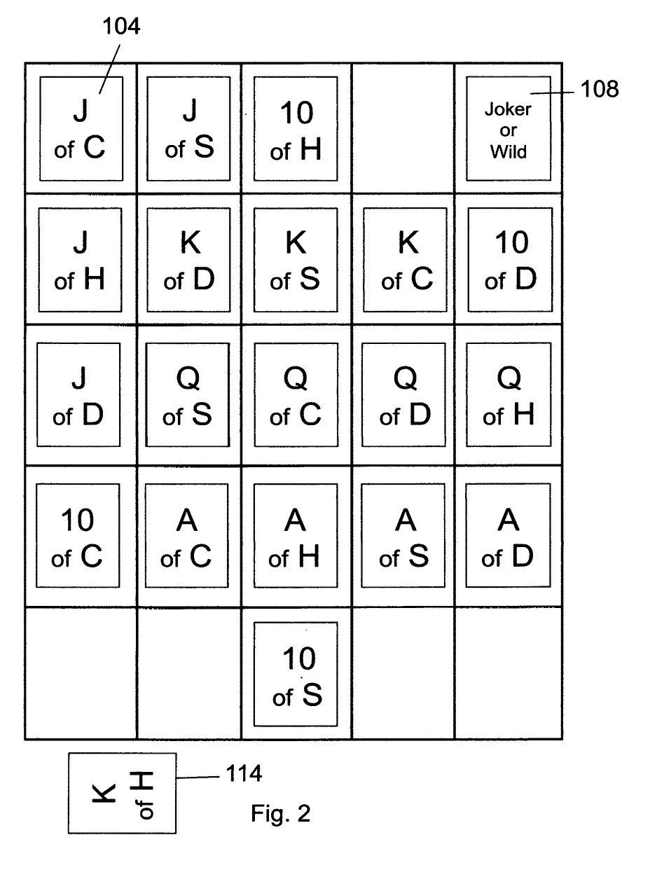

Finally, if the player is able to place the money card 108 off the grid, the player may be awarded an additional bonus prize. In this example, the additional bonus prize may be $25,000. FIG. 2 shows an example of the outcome of such a game.

The present invention is also directed to a game portion in which players, such as contestants on a game show, provide answers to clues in which the answers contain a lexicon error that the contestant must first resolve before providing the answer to the clue. Contestants are optionally awarded points in the form of cards distributed according to a predetermined set of rules based on how fast each contestant correctly answers each clue. The value of the cards at the end of the game determines the player of the game. The player can then proceed to a bonus round of the game in which the contestant's ability to think and strategize is tested, such as with other games provided by this invention. Prizes may be awarded based on the outcome of either game portion or from two or more combined.

In an embodiment, the games of this invention comprise two stages. An option for a preliminary stage is to test the contestants' knowledge and thinking and determine a winner. The winner then may proceed to the main stage, a second stage or a bonus round of a game show. In a second stage, the contestants' ability to strategize can be tested. In addition, some luck may be involved. During the second stage, the contestants may have the opportunity to win prizes depending on the outcome of that stage or a combination of more than one stage. Prizes can be in the form of cash prizes, gift certificates, vacations, consumer goods, and the like.

During the preliminary stage, contestants are presented with a plurality of available answers. Unlike typical games, however, the available answers are presented with a lexicon error. For the purposes of this application, a lexicon error is a word deliberately spelled incorrectly. In some embodiments, the word may contain all of the letters in the word, but in a different order. For example, a scrambled word may be a type of lexicon error because all of the letters in the word are present but arranged in a random order. Similarly, a word spelled backwards is a type of lexicon error because all of the letters are present but arranged in reverse order. In some embodiments, one or more letters may be substituted with an incorrect letter. Therefore, in order for the contestant to understand what the available answers are, the contestant must be able to correctly decipher what the available answers are when the lexicon error is corrected. In an embodiment, the available answers are presented backwards.

The available answers may be presented briefly to the contestants, then removed. In some embodiments the available answers may be flashed on a screen for a predetermined period, for example, less than one second. In an embodiment, the available answers are flashed on the screen for less than half a second. More preferably, the available answers may be flashed on the screen for one-tenth ( 1/10) of a second. In some embodiments, the available answers may be flashed on the screen simultaneously for a predetermined period of time. In some embodiments, the available answers may be flashed on the screen sequentially or in series for a predetermined period of time. By way of example only, the first available answer may be flashed on the screen for 1/10 of a second, then as the first available answer disappears, the second available answer may flash on the screen for the same period of time, and as the second available answer disappears, the third available answer may appear on the screen, and so on. In an embodiment, there may be four available answers.

Once the available answers have been presented to the contestants, the clue is presented to the contestants. The clue may be a question, statement, phrase, and the like that most closely associates with one of the available answers. The clue may be presented to the contestants for example on a screen and/or read aloud to the contestants by a host.

In an embodiment, after the clue is presented to the contestants, the contestants have an opportunity to submit their answers by activating an actuator. The actuator may be a button, a lever, a touchscreen, and the like. In some embodiments, each contestant may be presented with multiple actuators, with each actuator associated with each one of the available answers. Therefore, activation of a specific actuator determines the contestant's selection of his or her answer. In embodiments using touch screens, the number of actuators is in reference to the number of areas on the screen, actuation of which, submits the answer selected. In some embodiments, multiple touch screens can be dedicated for each answer, for each contestant.

In an embodiment, the contestants' order in which the answers are received is monitored and recorded. The first contestant to submit a correct answer is deemed the winner of the particular round. The second contestant to submit a correct answer in the particular round takes second place, the third contestant to submit a correct answer in the particular round takes third place, and so on. In an embodiment, only the first three places have significance, but other places can have significance as well.

In an embodiment, the first three contestants to submit the correct answer are awarded with points, and the first round of the first stage is complete. This process of submitting answers to clues and being awarded points can continue for a predetermined number of rounds. At the end of the predetermined number of rounds, a player is declared based on the points awarded to proceed to the second stage of the game.

In an embodiment, the points are awarded based on a distribution of cards. For example, 20 cards from a standard deck of cards may be used. By way of example only, the 20 cards may be the four aces, the four twos, the four threes, the four fours, and the four fives. These cards will be shuffled and presented face down so that the contestants cannot see the value of the cards. For each round, the winner of the round will receive two cards face down, and the second and third place contestants will each receive one card face down as well. This process of awarding cards continues for each round. Any number of cards can be awarded so long as the winner of the round has some kind of advantage over the others. In this example, the winner receives more cards than the other contestants.

Once all the rounds have been played, the player of the first stage is determined. In the example above, since there were 20 cards, and four cards were distributed per round, five rounds would have been played. To determine the player, the cards are revealed and assessed. The cards may be revealed in a particular order. For example, the contestant with the most number of cards or the fewest number of cards reveals one of his or her cards. For the sake of clarity and ease of description, this contestant will be referred to as the first contestant. In some embodiments, the first contestant can select any of the cards in his or her pile. In some embodiments, the first contestant selects the card based on the sequence of how he or she received the card. Therefore, in one embodiment, the first card received may be the first card revealed. Alternatively, the last card received may be the first card revealed. Once the card is revealed, the value of the card is identified. The value of the card is simply the number shown on the card. For an ace, a value can be assigned, such as a value of 1, 11, or some other number. In this example, the ace has a value of 11.

Once the value of the first card revealed is identified, the second contestant reveals his or her first card. The second contestant can be determined by his or her physical position (e.g., left or right) relative to the first contestant or by the number of cards won. For example, the second contestant may be the contestant to the right or to the left of the first contestant. Alternatively, the second contestant to reveal his or her card may be the contestant with the second fewest number of cards or the second most number of cards to correspond with the criteria used to select the first contestant to reveal his or her cards.

In this example, the contestants are arranged in a circle, and the second contestant is the contestant to the left of the first contestant. Therefore, cards are revealed in a clockwise fashion. The second contestant reveals his or her first card based on the same rule described above for the first contestant. If the value of the second contestant's first card is lower than the value of the first contestant's first card, then the second contestant reveals his or her next card based on the same rules described above. The second contestant continues revealing his or her cards until the cumulative value of the second contestant's revealed cards exceeds the value of the first contestant's first card. If the cumulative value of the second contestant's revealed cards are unable to exceed the value of the first contestant's first card, then the second contestant is eliminated and the process repeats for the third contestant.

If on the other hand, the second contestant is able to achieve a cumulative value of revealed cards that exceeds the first contestant's first card, then the third contestant proceeds to reveal his or her cards until he or she is able to achieve a cumulative value of revealed cards that exceeds the cumulative value of the second contestant's revealed cards.

This process of revealing cards and eliminating contestants continues until a single contestant remains having the highest value of revealed cards. This contestant is deemed the player of the first stage.

In alternative embodiments, all of the cards can be revealed simultaneously, and the player can be determined by the total cumulative value of the cards held, or the player can be determined by the probability of receiving the hand dealt consistent with the rules of poker, and the like.

The player then is optionally moved on to the next stage of the game, such as a main or bonus round. In this stage, the contestant utilizes might need to use strategic thinking to win a prize.

In another embodiment, the first three contestants to submit the correct answer are again awarded with points. In this embodiment, the points are again awarded based on a distribution of cards. For example, 16 cards from a standard deck of cards may be used. By way of example only, the 16 cards may be the four twos, the four threes, the four fours, and the four fives. These cards will be shuffled and presented face down so that the contestants cannot see the value of the cards. For each round, the winner of the round will receive, by choosing, two cards face down, and the second and third place contestants will each receive one card face down as well. Before going on to the next round, the chosen cards are revealed by the players.

This process of awarding cards continues for each round. After three rounds have been played, each of the players point scores are tallied, and the player with the fewest points is eliminated. Announcements are made about the ranking of the players and their scores. Four concealed cards remain.

Two cards with the value of seven each are added to the remaining four cards, and the six concealed cards are shuffled. The player in third position with the most points selects two of these cards and keeps them concealed. The player in second selects two from the remaining four cards and keeps them concealed.

Two more cards are added to the remaining two. They are two aces worth 11 points each. These four are reshuffled and placed back concealed on the playing surface. The player who was in first position, that is the player with the highest revealed point total, selects two of these last four cards and keeps them concealed.

The concealed cards that have been selected by the players are now revealed in this order—first the player in the “show” position and then the “place” position. Before the player in the “win” position reveals their cards, it is announced that aces had been added that are worth 11 point each and that if this player chose two aces that they'd likely win, and that if they've chosen both aces will get double the winnings for this game.

The value of each of the cards is simply the number shown on the card and the aces are worth 11 points, as stated. The final player's cards are revealed, and the cards are tallied.

The third place player wins $1,000. The second place player wins $2,500. The first place winner wins $5,000, unless they have selected both aces, in which case they win $10,000

The following provides specific examples of the game described above being played. We start with five contestants standing at desks. Each has in front of him/her four horizontal bars, laying flat top to bottom. All contestants and the audience are shown the four possible answers (each answer containing a lexicon error) to the questions about to be asked. If we could see them all at once those answers would look like this:
ETIMANYD
EBAB
DNOMAID
DRAOBHSAW

These are the multiple-choice answers spelled backwards for the upcoming clue. The answers are presented quickly, one at a time, visible briefly in some sequence, such as predetermined sequence or a random sequence. Each answer would remain on the screen for about one-tenth of a second.

Next, the clue is displayed that determines which of those flashing answers is correct. In this example, the clue may be: “Don't forget to RUN, after you light the fuse.”

As the host starts to read the clue, the blank answer-strips horizontally stacked in front of each contestant will be activated and each will store (but not display) whether the contestant answered in the first, second, or third fastest time. If a contestant's answer was not in the top three fastest entries, that position will display a small “x.”

The host then asks to see who answered in the top three positions, and those words appear in front of those contestants.

Next, the host introduces the deck of twenty cards that will later determine who wins.

The deck contains four each of twos, threes, fours, and fives, each card worth its face value. The deck also contains four aces, each worth 11 points.

The contestant who finished first is awarded two cards, placed face down in front of him.

The contestants who finished second and third are each given just one card in the same manner. Therefore, it is unknown what card value any contestant has received at this point, and the first round is complete.

The contestants play through four more rounds as described above.

For example, in the next round, the four flashing, backwards answers are:
EIKCAJ
EBAB
ENILORAC
NOSREFFEJ

The clue may be: “The nickname Ruth was known by.”

The winner of this round is determined as described above. When the contestants have played through five rounds, the player can be determined by seeing how the contestants' cards add up.

In this example, the contestant who has the fewest cards is asked to reveal one card. For this example, assume the card is a three.

The contestant to his/her left now reveal cards until he/she beats that three. This continues clockwise, until each contestant has exceeded his/her predecessor, looking for higher scores each time. And when a contestant fails to beat the contestant before him/her, the low contestant is out of the round, and the scoring moves on clockwise. Contestants keep whatever points they have won as they play.

This continues until all cards are revealed. The highest contestant after the fifth round wins.

In case of ties, one tie-breaker question is asked, and the contestant who is the first to answer correctly is the player and moves to stage 2 or the bonus round as described above.

This game can be played as a board game, as a television game show, online, as an app for a smart phone or a tablet, as a computer game, in casinos, with casino gaming equipment, and the like.

A person of ordinary skill in the art will appreciate that it is possible to implement the concepts of the present invention in computer software rather than using an actual game board and game pieces, the size of the game pieces and game board being selected based upon the number of game piece utilized in playing the game as well as the anticipated resolution of the device on which the game will be played. One advantage of implementing the game in computer software is that the game pieces can easily be shuffled. Another advantage of computer implementation is that the game can easily be replayed from an earlier stage of game play, or from the same initial order of the game pieces, so to try the effect of different strategic decisions or to compare the skills of various players. Additionally, the game can be adapted for interactive play over a global computer network. Such a configuration would permit competitions to be easily organized and conducted to determine who possesses the highest level of skill.

The game can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the game can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers. These devices can be used by the contestants to submit their answers.

Network adapters may also be coupled to the system to enable the data processing system to become coupled to other data processing systems through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber.

Furthermore, computers and other related electronic devices can be remotely connected to either the LANs or the WAN via a digital communications device, modem and temporary telephone, or a wireless link. It will be appreciated that the Internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. It will be appreciated that the present application could apply in any such interactive communication environments, however, for purposes of discussion, the Web is used as an exemplary interactive hypertext environment with regard to the present application.

The WWW browser may retrieve programs from the web server, such as JAVA applets, for execution on the client computer. Finally, the WWW browser may include optional software components, called plug-ins, that run specialized functionality within the browser.

Players can, therefore, play remotely against each other when the system is employed on the Internet.

This invention provides software compositions for playing the games of this invention. This invention also provides devices having or connecting to software compositions for playing the games of this invention.

In an embodiment, there are no rules for scoring and no scoring occurs.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of playing a solitaire game comprising:
a) providing a set of concealable game pieces wherein said game pieces have a first means for grouping said game pieces into at least 2 groups;
b) providing a game board having a plurality of locations for placement of said game pieces wherein there is a first percentage of more locations than there are game pieces;
c) providing at least about as many areas of said game board locations as there are groups, each area having a board location and board placement, each area comprising at least as many locations as are in each group of game pieces such that each group can fit in each area with only one game piece per location and wherein all groups fit on said game board simultaneously with only one piece per location;
d) providing an order for dealing a second percentage of concealed and revealed game pieces and a rhythm for dealing said concealed and revealed game pieces;
e) providing scoring instructions comprising how many points are to be awarded for each possible set of two or more of said game pieces within a group placed in an area;
f) concealing and randomizing said game pieces;
g) dealing a player a revealed or concealed first or next game piece according to said rhythm and order;
h) said player selecting a first or next location of said game board and placing said first or next, revealed or concealed game piece in said location of said game board, said player aiming to place all of said game pieces in each of said at least two groups in one of said areas;
i) revealing said placed game piece if said first or next game pieces was concealed;
j) repeating steps g) through i) according to said order and rhythm for dealing concealed and revealed game pieces until there are no more of said game pieces to be dealt, placed and optionally revealed; and
k) scoring said played game pieces per said scoring instructions.

2. The method of claim 1 comprising:
providing at least about 10% more board locations than game pieces; and
providing a percentage concealed game pieces selected from the group consisting of: at least about 5%, at least about 10%, at least about 20% and at least about 25%.

3. The method of claim 1 comprising:
a) 20 game pieces that are a subset of a standard 52-card deck wherein said first means is a value on said card, wherein there are five groups, wherein said value is selected from the group consisting of tens, jacks, queens, kings and aces;
b) providing a game board wherein said first percentage is 25% with 25 locations arranged in a 5×5 square;
c) providing 5 areas that are rows of said 5×5 square;
d) where said rhythm for dealing is one at a time, said second percentage of concealed game pieces is at least about 25%, and said order for dealing said game pieces comprises: 1 concealed, 2-4 revealed, 5 concealed, 6-8 revealed, 9 concealed, 10-12 revealed, 13 concealed, 14-16 revealed, 17 concealed, and all options for 18-20;
e) scoring a placement of all four game pieces of a group within one of said rows, wherein all four game pieces are adjacent to one another, with about 1 or more points;
f) dealing a player a first or next game piece according to said rhythm and order;
g) said player selecting said first or next location and placing said first or next game piece;
h) revealing each played and concealed game piece;
i) repeating steps f) through h) for each of said 20 game pieces; and
j) scoring.

4. The method of claim 1 wherein:
a) said first means comprises a number, a value, a category or a suit;
b) said method further comprises a second means comprising a number, value, category or a suit;
c) said at least two groups are about the same size;
d) said game board comprising about 5% or more locations than game pieces;
e) said game board comprising said plurality of locations is arranged in a rectangle, which may comprise a square, wherein each of the sides of said rectangle is at least as many locations as the size of the smallest group of game pieces;
f) said areas comprise both columns and rows; and
g) said scoring instructions comprise scoring both first and second means and both columns and rows.

5. The method of claim 1 also comprising:
a) providing at least one additional game piece;
b) adding said at least one additional game piece while concealed to a remaining set of about 4 or fewer game pieces and randomizing said game pieces before they are dealt;
c) modifying said scoring instructions to award more or fewer points for including or excluding said at least one additional game piece from said game pieces that get played on said board; and
d) stopping before completing step j) when there are as many game pieces yet to be dealt as there are additional game pieces added.

6. The method of claim 1 wherein at least about 20% of said game pieces are concealed and said order for dealing said at least about 20% concealed game piece are positioned so that about 50% or more of said concealed positions are about equidistantly positioned in the dealing order throughout said set of game pieces.

7. The method of claim 1 comprising providing scoring instructions comprising how many points are to be awarded for each possible set of two or more of said game pieces that are adjacent to one another within a group placed in an area, with no non-group game pieces between them.

8. The method of claim 7 comprising scoring instructions requiring all of the game pieces in a group to be adjacent to each other in one area for any points to be awarded for said game pieces in said group.

9. The method of claim 1 comprising a first means for grouping said game pieces into at least 4 groups.

10. The method of claim 1 also comprising a second means for grouping said game pieces into at least 3 groups.

11. The method of claim 1 wherein areas to be scored comprise at least one more location than the size of each of the largest group.

12. A game comprising:
a) a set of concealable game pieces, each having a first means for grouping each of said pieces into at least one of at least two groups;
b) a game board having a plurality of locations for receiving one each of said game pieces wherein there are at least 5% more locations than game pieces;
c) wherein said game board is configured to have at least as many areas as there are groups, each area having at least as many locations as there are in the largest group of said at least two groups, wherein said entire set of game pieces can fit in said areas simultaneously, one game piece per location;
d) rules for play and scoring comprising:
i) at least 5% of game pieces to be dealt and played concealed and an order for dealing and playing said concealed game pieces and when to reveal said concealed game pieces;
ii) when to reveal said concealed game pieces;
iii) which of said areas are useful for scoring points;
iv) how many game pieces in one of said groups must be in an area to score points;
v) whether said game pieces in one group in one area must be adjacent to one another to score points; and
vi) how many points can be scored for the different possible categories of configurations said game pieces may be placed on said game board.

13. The game of claim 12 wherein there are at least about 10% more locations than game pieces and wherein the rules specify that at least about 15% of game pieces are to be dealt and played.

14. The game of claim 12 comprising:
a) a subset of a standard deck of playing cards comprising: four tens, four jacks, four queens, four kings and four aces, said 20 cards divisible into 5 groups;
b) a game board comprising 25 locations in a 5×5 square, said game board having 5 rows and 5 columns wherein said game board has 25% more locations than there are cards;
c) the board comprises 5 areas, each comprising one of said rows of 5 locations;
d) said rules comprise:
i) at least about 25% of said cards are to be concealed and dealt and played about one at a time comprising this order: 1 concealed, 2-4 revealed, 5 concealed, 6-8 revealed, 9 concealed, 10-12 revealed, 13 concealed, 14-16 revealed, 17 concealed, and all options possible of revealed and/or concealed for 18-20;
ii) said cards are revealed promptly after being played;
iii) said 5 row areas are useful for scoring points;
iv) all of the cards in a group must be in one of said rows to score points;
v) said cards in a group in a row must also be adjacent one another to score points; and
vi) at least one point is scored for when all of the cards in one of said groups are adjacent to each other in one of said rows.

15. The game of claim 12 further comprising one or more additional game piece wherein said rules comprise directions for dealing, playing and scoring said additional game piece.

16. A method of playing an electronic solitaire game comprising:
a) electronically storing a signal representation for or displaying a set of concealed game pieces wherein said game pieces have a first means for grouping said game pieces into at least two groups;
b) electronically displaying a game board having a plurality of locations for placement of said game pieces, wherein said game board has a first percentage of more locations than there are game pieces, wherein said electronically displayed game board comprises at least about as many areas as there are groups, each said area comprising at least as many locations as are in the largest group of game pieces, wherein all of said groups fit on said game board simultaneously with only one piece per location;
d) providing an order for electronically displaying to a player said game pieces wherein a second percentage of said game pieces are displayed concealed and the rest are displayed revealed;
e) randomizing said displayed game pieces;
f) electronically dealing to a player a revealed or concealed first or next game piece according to said order, at a rhythm of about one at a time;
g) said player selecting a first or next location of said game board and electronically displaying said first or next, revealed or concealed game piece in said location of said game board, said player aiming to place all of said game pieces in each of said at least two groups in one of said areas;
h) electronically revealing said placed game piece if said first or next game pieces was concealed; and
i) repeating steps f) through h) according to said order and rhythm electronically dealing and displaying concealed and revealed game pieces until there are no more of said game pieces to be dealt, placed and optionally revealed.

17. The method of claim 16 further comprising:
j) providing and displaying scoring instructions comprising how many points are to be awarded for each possible set of two or more of said game pieces within a group placed in an area, said instructions displayed before step f); and
k) automatically scoring said played game pieces per said scoring instructions.

18. The method of claim 17 comprising:
a) displaying a game board having a first percentage more locations than game pieces is selected from the group consisting of at least about 10% more, at least about 15% more, at least about 20% more, at least about 25% more, and at least about 30% more; and
b) comprising displaying a second percentage of game pieces concealed selecting from the group consisting of at least about 5%, at least about 10%, at least about 20% and at least about 25%.
